(19) United States
(12) Patent Application Publication
(10) Pub. No.: US 2024/0406862 A1
(43) Pub. Date: Dec. 5, 2024

(54) METHOD FOR DETERMINING A SET OF NETWORK CONFIGURATIONS FOR A WIRELESS DEVICE COMPRISING AN INTERMITTENT ENERGY SOURCE

(71) Applicant: Telefonaktiebolaget LM Ericsson (PUBL), Stockholm (SE)

(72) Inventors: Kittipong Kittichokechai, JÄRFÄLLA (SE); Talha Khan, SANTA CLARA, CA (US); Hieu Do, JÄRFÄLLA (SE); Miguel Lopez, AACHEN (DE); Jeong Hun Kim, KANATA (CA)

(21) Appl. No.: 18/262,766

(22) PCT Filed: Jan. 27, 2021
(86) PCT No.: PCT/SE2021/050050

§ 371 Date: Jul. 25, 2023

(51) Int. Cl. H04W 52/02; H04L 5/00

(52) U.S. Cl. CPC H04W 52/0216; H04L 5/0091

(57) ABSTRACT

A method performed by a wireless device (200) for determining a set of network configurations for the wireless device (200) in a wireless communications network (100). The method comprise obtaining (202) at least one set of network configurations that are adapted for wireless devices comprising an intermittent energy source (520). The method also comprises determining (204), based on information indicating an amount of energy available to the wireless device (200) originating from an intermittent energy source (520) of the wireless device (200), a set of network configurations for the wireless device (200) from at least two sets of network configurations comprising the obtained at least one set of network configurations.

### TECHNICAL FIELD

The present disclosure relates to network configuration of wireless devices in a wireless communications network. In particular, but not exclusively, the disclosed technology relates to a network node, a wireless device and methods therein for determining a set of network configurations for a wireless device in a wireless communications network.

### BACKGROUND

In the past years, wireless communications has been expanding from human-centric communications, e.g., communication using phones, to also include machine-type communication, MTC, e.g., communication with sensing devices deployed in houses, streets, factories. This trend is being driven by numerous applications in the Internet of Things, IoT, domain, making things “smarter” as in smart houses, smart cities, smart factories, and smart grids.

Wireless connectivity for IoT or massive machine-type communications, mMTC, devices can be provided by several technologies such as those based on Bluetooth, Zigbee, LoRa, Sigfox, as well as cellular technology. Among these options, the cellular technology, i.e. developed by within the 3GPP framework, has many benefits in terms of Quality-of-Service, QoS, reliability, latency, security and coverage.

So far, 3GPP has offered several solutions for mMTC in its technical specification releases. Starting in Release 13, Rel-13, two parallel tracks for MTC have been offered, referred to as LTE-M and NB-IoT. LTE-M targets a class of devices which is less capable than normal smartphones by limiting the operation bandwidth to a maximum of 6 LTE resource blocks. The supported peak rate of LTE-M in Rel-13 is 1 Mbps in both uplink and downlink. NB-IoT, on the other hand, targets even less capable devices by limiting the operation to a maximum of one LTE resource block. As a result, the NB-IoT in Rel-13 supports a peak data rate as low as 27 kbps on the downlink and 60 kbps on the uplink. In the subsequent releases, both LTE-M and NB-IoT have been improved to support higher peak data rates.

A typical IoT device is powered by a small battery, e.g. coin cell, and features a low-complexity design with limited computational capabilities, low cost and infrequent data communications. A common characteristic of a large class of IoT devices, such as sensors, smart meters, and wearables, is the limited power availability for communication, as compared to some other types of traditional wireless devices like smart phones, tablets, or devices mounted on vehicles. Therefore, prolonging the device battery life has been a key design consideration for mMTC. The technical solutions offered by 3GPP have been designed to cater to these characteristics of the IoT devices. For example, NB-IoT was introduced with the requirement of achieving a 10 years life operating on a 5 Wh battery, assuming a daily delivery of a 200 bytes uplink message followed by a 20 byte downlink message. In order to meet these requirements, several power saving mechanisms were considered in the initial design and later updated to further evolve NB-IoT in the following releases.

Some of the notable power saving mechanisms are:
eDRX: extended Discontinuous Reception allows power saving by allowing the device to not monitor the network for scheduling for a preconfigured period of time.
PSM: Power Saving Mode allows the device to sleep without having to re-attach to the network when it wakes up.
WUS: Wake-up-signal allows the device to determine when the next scheduling grant/paging will occur without having to blindly search & decode, thus conserving power.
EDT: Early data transmission allows transmission of small data packet in Msg3 of the random access procedure to save power and reduce latency.
PC6: Power class 6 further restricts the maximum transmit power of the device to 14 dBm, allowing to trade off power with coverage.

### Zero-Power/Self-Powered Devices

With the evolution of semiconductor and device technologies, a new class of IoT devices, hereafter interchangeably referred to as self-powered or zero-power or zero-energy devices, is emerging. As the name implies, a self-powered or a zero-power IoT device is usually not powered by a battery. Instead, it harvests energy from the ambient energy sources such as light, motion, RF signals, heat, etc. There are several advantages of using a zero-power device as compared to a battery-powered one. First, replenishing energy from the environment helps reduce both the energy costs and the carbon footprint. Second, manual intervention for battery replacements, and disposal, is not needed, which considerably reduces the maintenance cost of IoT devices. Third, zero-power devices are designed to have extremely low complexity, which further reduces the device cost. The potential applications include smart meters, smart sensors, wearables, etc.

However, zero-power devices also come with certain limitations. Typically, depending on the environment, the power availability at a zero-power device can be scarce, intermittent and unreliable. This is different from a battery-powered device where the power is assumed to be available throughout the device lifetime. Furthermore, a zero-power device may also have limited transceiver capabilities to enable ultra-low power operation. This is because on one hand the amount of power available to an energy harvester usually depends on the power density in the ambient environment, which can be very low, often in the order of a few tens or hundreds of microwatts per cubic centimeter. On the other hand, the energy requirements for wireless communications are typically higher, especially if the application requires communication ranges in the order of tens of meters or larger. In this case transmit powers in the order of at least 1 mW could be necessary. It follows that the IoT devices must accumulate sufficient energy in order to be able to operate. In addition, microcontroller units and other electronics that may be present in the IoT device typically require voltages much larger that the input voltage delivered by the transducer. Hence, the output voltage must often be boosted and regulated. Thus, zero-power devices generally require duty-cycled operation, and are unable to operate if the stored energy is insufficient, or if the power management circuitry is unable to deliver to the radio or application circuitry a voltage exceeding a minimum threshold.

### Network Configuration Parameters

Radio access procedures in cellular wireless communication are typically based on some form of network configurations. Conventional network configurations such as RRC configurations are provided to the wireless devices in either cell-specific or device-specific manner. During initial access procedure, some cell-specific configurations are relevant to provide the wireless devices with a common set of configuration parameters, whereas after connected to the cell, each wireless device can be further configured with some device-specific configuration parameters to be used for data transmission later on.

Network configurations typically include several parameters related to how the network would schedule the devices and how the devices perform the communication accordingly. The parameters can cover different physical layer (PHY) aspects such as:
PDCCH monitoring (e.g., by Search Space, ControlResourceSet),
UL control transmission (e.g., by PUCCH-configuration),
DL and UL data transmission (e.g., by PDSCH-configuration, PUSCH-configuration), as well as some semi-persistent or configured grant transmission (e.g., by SPS-configuration, ConfiguredGrantConfig).

In New Radio, NR, multiple sets of configurations for SearchSpace and ControlResourceSet IEs can be provided to the device. In NR Rel-16, two separate PUCCH-configuration can be configured to a device to enable the construction of two simultaneous HARQ-ACK codebooks with different PHY priorities.

However, for configurations related to data transmission such as PDSCH-configuration and PUSCH-configuration, only one set of configuration parameters is given to the device per Bandwidth Part, BWP. When the network wants to change some values of the parameters, either RRC re-configuration or switching of BWP by DCI transmitted in PDCCH is needed, requiring further data exchange between the network and devices.

Furthermore, related to BWP, if a wireless device is configured with BWP-inactivity timer, the wireless device switches to the default or initial BWP when the BWP-inactivity timer associated with the active Downlink-BWP, DL BWP, expires. However, to switch to an active BWP which is not the initial BWP or default BWP, a PDCCH indicating the active BWP is required.

### SUMMARY

The disclosed technology seeks to mitigate, obviate, alleviate, or eliminate one or more of the above example problems with current technology and/or to improve communications in a wireless communications network. Various aspects of the disclosed technology are as set out in this summary section with examples of embodiments, which may be preferred embodiments.

According to a first aspect of embodiments herein, a method performed by a wireless device for determining a set of network configurations for the wireless device in a wireless communications network is provided. The method comprises obtaining at least one set of network configurations that are adapted for wireless devices comprising an intermittent energy source. Also, the method comprises, determining based on information indicating an amount of energy available to the wireless device originating from an intermittent energy source of the wireless device, a set of network configurations for the wireless device from at least two sets of network configurations comprising the obtained at least one set of network configurations.

According to a second aspect of embodiments herein, a wireless device for determining a set of network configurations for the wireless device in a wireless communications network is provided. The wireless device being configured to obtain at least one set of network configurations that are adapted for wireless devices comprising an intermittent energy source. The wireless device is also configured to determine based on information indicating an amount of energy available to the wireless device originating from an intermittent energy source of the wireless device, a set of network configurations for the wireless device from at least two sets of network configurations comprising the obtained at least one set of network configurations.

According to a third aspect of embodiments herein, a method performed by a network node for determining a set of network configuration for a wireless device in a wireless communications network is provided. The method comprises receiving, from the wireless device, signalling indicating a set of network configurations that are adapted for wireless devices comprising an intermittent energy source. Also, the method comprises determining the set of network configurations for the wireless device in the wireless communications network according to the indicated set of network configurations.

According to a fourth aspect of embodiments herein, a network node for determining a set of network configuration for a wireless device in a wireless communications network is provided. The network node is configured to receive, from the wireless device, signalling indicating a set of network configurations that are adapted for wireless devices comprising an intermittent energy source. The network node also being configured to determine the set of network configurations for the wireless device in the wireless communications network according to the indicated set of network configurations.

According to a fifth aspect of the embodiments herein, computer programs are also provided configured to perform the methods described above. Further, according to a sixth aspect of the embodiments herein, carriers are also provided configured to carry the computer programs configured for performing the methods described above.

By having a wireless device capable of determining a set of network configurations from sets of network configurations comprising a set of network configurations adapted for wireless devices comprising an intermittent energy source, the wireless device is able to determine different sets of network configurations based on information indicating the amount of energy available to the wireless device. This means that the wireless device may autonomously switch between one set of network configurations enabling a normal operation mode when the energy availability is high, and one set of network configurations enabling a low-power mode when the energy availability is low. This will advantageously also not require any additional communication in the wireless communications network. Hence, communications in the wireless communications network is improved.

### BRIEF DESCRIPTION OF THE DRAWINGS

Some embodiments of the disclosed technology are described below with reference to the accompanying drawings which are by way of example only and in which:

FIG. 1 schematically illustrates a radio access network in which network configurations of wireless communications devices are determined according to some embodiments of the disclosed technology,

FIG. 2 is a flowchart depicting embodiments of a method in a wireless device,

FIG. 3 is a flowchart depicting embodiments of a method in a network node,

FIG. 4 is a signalling diagram illustrating embodiments of a wireless device, a network node, and at least one other wireless device in a wireless communications network,

FIG. 5 is a block diagram depicting embodiments of a wireless device, and

FIG. 6 is a block diagram depicting embodiments of a network node.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

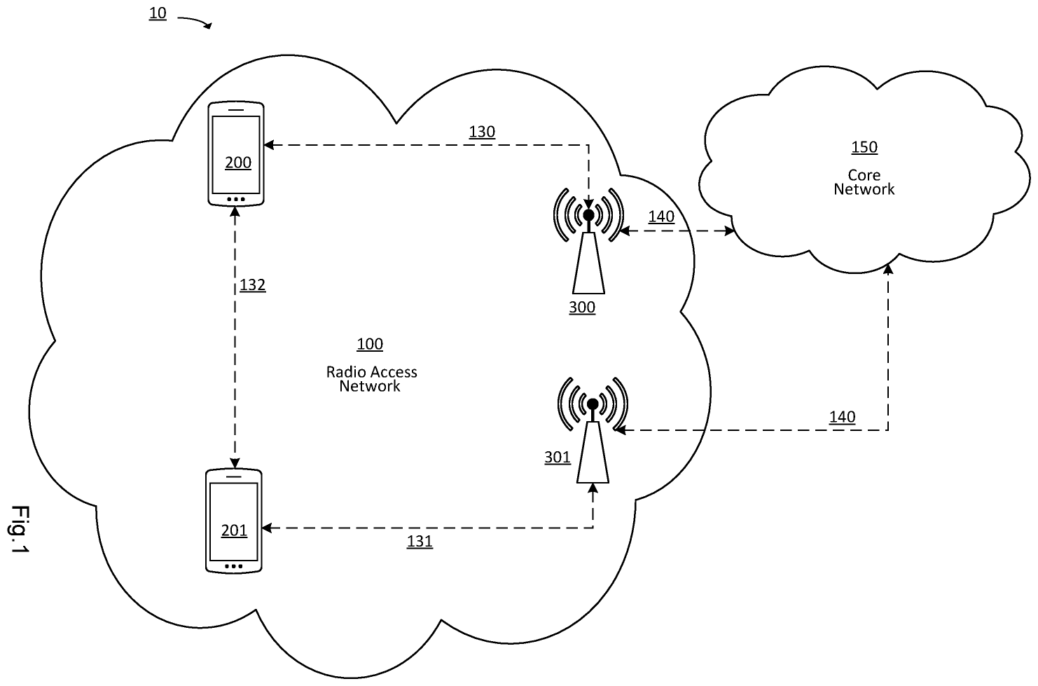

FIG. 1 illustrates a simplified architecture of a wireless communications network 10. For the sake of the embodiments herein, the wireless communications network 10 is described here in FIG. 1 as an LTE-based radio communications network, but may also employ technology of any one of Long Term Evolution (LTE), LTE-Advanced, Wideband (WCDMA), Code Division Multiple Access Global System for Mobile communications/Enhanced Data rate for GSM Evolution (GSM/EDGE), Worldwide Interoperability for Microwave Access (WiMax), Ultra Mobile Broadband (UMB) or GSM, or any other similar network or system. The wireless communication network 10 may also be an Ultra Dense Network, UDN, which e.g. may transmit on millimetre-waves (mmW). Furthermore, in different embodiments, the wireless communication network 10 may comprise any number of wired or wireless networks, any number of wireless devices, any number of network nodes, and/or any other components or systems that may facilitate or participate in the communication of data and/or signals over radio links in the wireless communications network 10.

As shown in FIG. 1, the wireless communication network 10 may comprise a Radio Access Network, RAN, 100 configured to communicate with a core network 150, e.g. over the communications links 140. The RAN 100 may comprise one or more wireless devices 200, 201 and one or more network nodes 300, 301. The one or more wireless device 200, 201 are configured to communicate with the one or more network nodes 300, 301 over radio links. For example, the wireless device 200 may be configured to communicate over a radio link served by the network node 300, i.e. over the wireless connection 130 between the wireless device 200 and the network node 300. Similarly, the wireless device 201 may be configured to communicate over a radio link served by the network node 301, i.e. over the wireless connection 131 between the wireless device 201 and the network node 301. The wireless device 200, 201 may also be adapted for a Device-to-Device, D2D, technology that allows LTE-enabled wireless devices to detect each other and to communicate directly. It relies on multiple enhancements to existing LTE standards including new functional elements and a sidelink, SL, air interface for direct connectivity between devices. This is illustrated by the wireless connection 132 in FIG. 1.

The wireless devices 200, 201 and network nodes 300, 301 may comprise various components described in more detail below. These components work together in order to provide wireless device and/or network node functionality. The wireless device 200 may refer to any type of wireless device or User Equipment, UE, communicating with a network node 300 and/or with another wireless device 201 in a cellular, mobile or radio communication network or system. Examples of such wireless devices are IoT devices, mobile phones, cellular phones, Personal Digital Assistants (PDAs), smart phones, tablets, sensors equipped with a UE, Laptop Mounted Equipment (LME) (e.g. USB), Laptop Embedded Equipments (LEEs), Machine Type Communication (MTC) devices, or Machine to Machine (M2M) device, Customer Premises Equipment (CPE), wireless device capable of machine to machine (M2M) communication, Vehicle-to-Vehicle, V2V, wireless device, or V2x wireless devices, etc. It should be noted that the wireless devices 200, 201 may be have a single antenna or multiple antennas, i.e. more than one antenna, in order to support Single User MIMO, SU-MIMO, or Multi-User MIMO, MU-MIMO, transmissions.

For the sake of describing the embodiments herein, the wireless device 200 may be a wireless device, such as, an IoT device, comprising an intermittent energy source. For example, the wireless device 200 may be configured to be powered by ambient energy sources, such as, light, motion, RF signals, heat, etc. This means that the energy availability at wireless device 200 most likely will be unreliable or intermittent. In view of this, the computational resources of the wireless device 200 may also be limited. The wireless device 200 comprising an intermittent energy source may also be referred to a self-powered, zero-power or zero-energy device, as described in the background above.

As part of developing the embodiments described herein, it has been realized that the existing mobile-communication network technology is conventionally designed for wireless devices with a reliable and predictable source of energy. This includes wireless devices, such as, e.g. cell phones, but also battery-powered machine-type wireless devices. For self-powered wireless devices, such as, e.g. machine-type wireless devices powered by energy harvesting, the energy availability may be scarce, intermittent and unpredictable. Hence, it may be concluded that there is a need for a redesign of the communication protocols which may take the peculiar characteristics of self-powered wireless devices into account.

In particular, physical-layer control signaling is onerous and imposes a rather heavy computational burden on the wireless devices. For example, wireless communications networks based on 5G may utilize so-called search spaces, which are sets of candidate control channels, among which a wireless device may perform blind detections to determine whether there are any Physical Downlink Control Channels, PDCCHs, transmitted to it, e.g. in a data payload referred to as Downlink Control Information, DCI.

Furthermore, for some network configurations, such as, e.g. Radio Resource Control (RRC) configurations, a single set of configuration parameters provided to a wireless device, e.g. configuration parameters for Physical Uplink Shared Channel (PUSCH), Physical Uplink Control Channel (PUCCH), Uplink Power Control per Bandwidth Part (BWP), etc., may not be suitable for self-powered wireless devices since the energy level of the self-powered wireless device will vary. Also, adapting the configuration parameters, e.g. by RRC re-configurations, requires an additional data exchange between the network and wireless device, and thus extra energy will be consumed by the wireless device. Changing configuration parameters dynamically, such as, e.g. by some indication in the DCI (e.g. potentially for BWP switching), is also not suitable for self-powered wireless devices, as it will require some form of PDCCH monitoring which will consume significant amount of energy at the wireless device.

As described by the embodiments herein, by having a wireless device capable of determining a set of network configurations from different sets of network configurations, wherein the different sets of network configurations comprise a set of network configurations adapted for a wireless device comprising an intermittent energy source, the wireless device may be allowed to conserve energy by autonomously switching to a different set of network configurations when necessary. For example, this may comprise switching from a normal operating mode to a low-power mode in order to save energy, or switch back to the normal operating mode for better performance once it has harvested or acquired a sufficient amount of energy. This switch may advantageously also be performed without any need for RRC reconfigurations or indications via DCI.

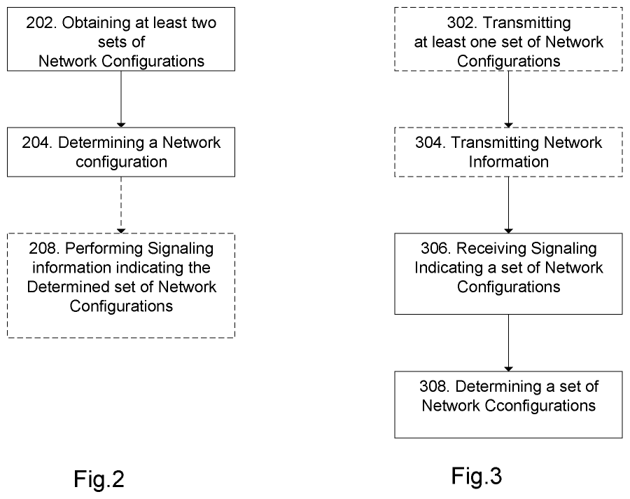

Examples of embodiments of a method performed by a wireless device 200 for determining a set of network configurations for the wireless device 200 in a wireless communication network 10, will now be described with reference to the flowchart depicted in FIG. 2. FIG. 2 is an illustrated example of actions or operations, which may be taken by the wireless device 200 in the wireless communications network 10. The method may comprise the following actions.

### Action 202

The wireless device 200 obtains at least one set of network configurations that are adapted for wireless devices comprising an intermittent energy source 520. This means, for example, that the wireless device 200 gains access to at least one set of network configurations adapted for self-powered wireless devices 200. Potentially, the wireless device 200 may here also gain access to at least one set of network configurations adapted for a conventional battery-powered wireless devices, i.e. non self-powered wireless devices.

In some embodiments, the wireless device 200 may receive at least one set of network configuration from a network node 300 or another wireless device 201 in the wireless communications network 10, and/or retrieving at least one set of network configurations predetermined in the wireless device 200. This means that the wireless device 200 may obtain at least one set of network configurations from at least two different sources. For example, a wireless device 200 may have one or more sets of network configurations predetermined in the wireless device 200. Also, the wireless device 200 may obtain, from a network node 300, at least one set of network configurations that are adapted for wireless devices which comprising an intermittent energy source 520. In this way, the wireless device 200 may be provided, from the network node 300, with at least one set of network configurations to be used in different states of the power/energy availability of the wireless device 200. According to another example, a wireless device 200 may receive one or more sets of network configurations from another wireless device, such as, e.g. the wireless device 201 over the wireless connection 132, in the wireless communications network 10. This means that the wireless device 200 may be able to receive information from additional sources in the wireless communications network 10. In this case, the wireless device 200 may not need to rely on good connection to a specific network node, such as, e.g. the network node 300.

### Action 204

After obtaining the at least one set of network configurations in Action 202, the wireless device 200 determines, based on information indicating an amount of energy available to the wireless device 200 originating from an intermittent energy source 520 of the wireless device 200, a set of network configurations for the wireless device 200 from at least two sets of network configurations comprising the obtained at least one set of network configurations.

This means that the determining of a set of network configurations, e.g. selecting and applying a set of network configurations, may be made based on measurements influencing the intermittent energy source 520 of the wireless device 200. If it is determined that a criteria is fulfilled, the wireless device 200 may change the current set of network configurations based on these measurements. In this way, the wireless device 200 may adapt the set of network configurations of the wireless device 200 to fit the current situation influencing the intermittent energy source 520. In other words, the wireless device 200 may autonomously select or switch the set of network configurations by itself by selecting and applying one set of network configurations out of multiple sets of network configurations. A sub-set of network configurations to be considered for selection by the wireless device 200 may also be indicated or further preconfigured by the network node 300. In some cases, the wireless device 200 may perform autonomous switching of the set of network configurations only when the wireless device 200 switches from and/or to certain network configurations, e.g. only from a default to low power set of network configurations or only from a low/lower to high/higher power set of network configurations.

Switching sets of network configurations may be based on a criteria and/or a threshold of energy availability at the wireless device 200. For example, for two sets of network configurations, where one set is suitable for low power consumption and another is suitable for normal power consumption, the wireless device 200 may switch to the set of network configurations suitable for low power consumption in case the energy of the wireless device 200 drops below a certain threshold. The threshold for switching from one to another set of network configurations may be different depending on the set of network configurations it switches to/from. For example, for the case of two set of network configurations, the wireless device 200 may switch from a normal-power to a low-power set of network configurations if the energy level at the wireless device 200 is below P1, while the wireless device 200 may switch back to the normal-power set of network configurations if the energy level at the wireless device 200 is above P2, where P2>P1. P1 and P2 may here be selected suitable threshold values. It should be noted the determining of a set of network configurations may comprise the selection of a set of network configurations, and applying the selected set of network configurations.

It should also be noted that the at least two sets of network configurations from which the determining is made, may not only comprise the obtained at least one set of network configurations, but also the current set of network configurations applied in the wireless device 200. It may further be noted that the set of network configurations currently applied to the wireless device 200 may be predetermined or pre-configured in the wireless device 200 or obtained from a network node 300 or from another wireless device 201. The set of network configurations currently applied to the wireless device 200 may be obtained together with other sets of network configurations obtained from the same or different source, such as, e.g. a network node 300 or another wireless device 200.

In some embodiments, the information indicating the amount of energy available to the wireless device 200 may be at least partly based on network information received from the network node 300 in the wireless communications network 10, operational information in the wireless device 200, and/or local site information of the wireless device 200. This means that the determining of the set of network configurations may be made based on measurements influencing the current and/or future amount of energy available to the wireless device 200 via the intermittent energy source 520 of the wireless device 200.

The measurements influencing the intermittent energy source 520 of the wireless device 200 may be information received from the wireless communications network 10, such as, e.g. network information, but may also be information retrieved from internal measurements in the wireless device 200, such as, e.g. operational information in the wireless device 200. Optionally, other information effecting the amount of energy available to the wireless device 200 may be obtained by external or internal sensors, i.e. local site information. In other words, multiple sets of network configurations may be provided for different communication procedures. For some communication procedures, the selection of one set of network configurations out of multiple sets of network configurations may be decided and indicated by the network node 300 while for others, it may be chosen autonomously by the wireless device 200 based on the energy level of the wireless device 200. In some cases, a single set of network configurations may be provided wherein the value of some parameters in the set of network configurations are decided by the network node 300, while the value of some other parameters may be chosen autonomously by the wireless device 200 based on the energy level of the wireless device 200.

In some embodiments, the network information may comprise a transmission request from the wireless network node 300 in the wireless communications network 10 indicating that the wireless network node 300 request a transmission from the wireless device 200, information relating to one or more local environmental conditions, and/or an update of one or more of the pre-determined conditions. This means that network information may comprise information indicating that the current amount of energy available to the wireless device 200 will be neglected or changed in the near future. In this way, one or more future upcoming events influencing the wireless device 200 ability to generate power, e.g. a change in weather, may be taken into consideration by the wireless device 200 when determining the set of network configurations for the wireless device 200.

The wireless device 200 may, according to some embodiments, consider a transmission request received from a network node 300 as an order to transmit using a specified network configurations despite other conditions, such as, e.g. certain operational information in the wireless device 200 and/or local site information of the wireless device 200. For example, transmitting using a higher transmission power despite that the amount of energy available to the wireless device 200 originating from an intermittent energy source 520 is low and/or that the local site information indicates a near future with low, or no possibility to charge the battery 528 using the intermittent energy source 520. In other words, the wireless device 200 may autonomously select a set of network configurations or switch to a set of network configurations based on a combination of the wireless device's 200 energy or power status and the reception of a message or a signal from a network node 300. For example, a wireless device 200 may receive control information from the network node 300 requesting multiple transmissions from the wireless device 200, such as, e.g. Channel State Information, CSI, reports or Received Signal Received Power, RSRP, measurements, within a short period of time. Based on the limited available energy of the wireless device 200, the wireless device 200 may need to select a low-power set of network configurations for the transmissions.

Another example is that one or more local environmental conditions may be changing. This means that the wireless device 200 may be able to charge the battery 528 of the wireless device 200, using the intermittent energy source 520 of the wireless device 200, due to the upcoming weather conditions. Another example is that one or more of the pre-determined conditions may be updated. This means that the wireless device 200 may obtain new thresholds which may determine when a low-battery mode will start and end. In these different ways, the wireless device 200 may advantageously obtain a faster communicating over the wireless communications network 10.

In some embodiments, the operational information may comprise at least one of: energy levels of the wireless device 200, profiles of the wireless device 200, duty cycles of the wireless device 200, a charging status of the wireless device 200, and/or traffic profiles of the wireless device 200. In some embodiments, the local site information may comprises at least one of: a date, a time of day, a period of time, a geographical location of wireless device 200, a local temperature and/or information indicating a local weather condition. This means that a wireless device 200 may consider a plurality of pre-determined conditions when determining which set of network configurations to use.

The wireless device 200 may consider re-occurring events, such as, e.g. times of day, and fixed conditions, such as, e.g. pre-determined periods of time. For example, two sets of network configurations, or network configurations parameters, may be provided to the wireless device 200 where one is to be used during the daytime and another is used during the night time. In this way, the wireless device 200 may adapt the power consumption of the wireless device 200 to situations when the ability to use the intermittent energy source 520 of the wireless device 200 is advantageous. In other words, switching of set of network configurations, or network configurations parameters, may be performed in a semi-static manner which may be pre-determined, based on time of the day, seasons, period of time, etc.

### Action 206

Optionally, the wireless device 200 may further perform signaling indicating the determined set of network configurations to a network node in the wireless communications network. This means that the wireless device 200 may indicate to the network, e.g. a network node 300, the set of network configurations determined in Action 204. In case of determining between two sets of network configurations, the indication may be in a form of signalling indicating the switch between the two sets of network configurations.

In some embodiments, the wireless device 200 may not provide an indication of the selected network configuration when switching from and/or to another set of network configurations, e.g. from a high-power to a low-power set of network configurations. One reason is that when operating with a low-power set of network configurations, the wireless device 200 may be prefer not to send any indication in order to save energy.

In some embodiments, the signaling may indicate the determined set of network configurations by using predetermined settings, or sets, of at least one of the following transmission characteristics: random access channel resources or occasions; uplink control channel resource; power level of the uplink transmission; Physical Resource Blocks, PRBs; symbols or slots that the wireless device 200 used for transmission; waveform of the uplink transmission; and scrambling sequence of uplink Resources Symbols, RS. This means that the wireless device 200 may implicitly indicate to the network node 300, the determined set of network configurations of the wireless device 200. In other words, the wireless device 200 may thus, without consuming additional power or energy in storage, signalling to the network node 300, the determined set of network configurations of the wireless device 200.

Implicit signalling may be particularly advantageous when a wireless device 200 is in a low-power mode, and do not want to waste power on explicitly transmitting an indication of the determined set of network configurations of the wireless device 200. According to one example, when the wireless device 200 performs random access, the network may pre-allocate uplink resources for the wireless device 200 for one or more set of network configurations. The information about which set of network configurations get allocated with uplink resources may be broadcasted using System Information, SI, or sent in a separate message specific for the wireless device 200. After initial access, if the wireless device 200 needs to switch from one set of network configurations to another, the wireless device 200 may transmit using the preconfigured uplink resources for the corresponding set of network configurations without a need to request resources for the newly determined set of network configurations. Here, the network node 300 may monitor both types of uplink resources. The network node 300 may also release the, resources configured for the wireless device 200 when the wireless device 200 goes from being in connected or inactive mode and into idle mode. Consider e.g. a case where the wireless device 200 autonomously selects an RRC configuration and the network node 300 has two set of network configurations, one for normal-power mode and another for low-power mode which correspond to separate time/frequency resources. Thus, when the wireless device 200 performs random access using resources configured for the normal-power mode, the network node 300 may also set aside separate uplink resources in case wireless device 200 later needs to switch to the low-power mode. If the network node 300 then monitors both types of uplink resources, the network node 300 will know which set of network configurations has been determined and is used by the wireless device 200. Moreover, the wireless device 200 may thus simply switch to the low-power mode without requesting any resources from the network node 300. However, when the wireless device 200 moves from connected or inactive mode into idle mode, the network node 300 may release those resources.

In some embodiments, the signaling may comprise transmitting a network configuration identifier indicating the determined set of network configurations. This means that signalling may be performed explicitly via an identifier of the determined set of network configurations. For example, the wireless device 200 may provide an explicit indication of a change of the set of network configurations of the wireless device 200 to the network node 300. The indication may include a configuration identifier of the selected set of network configurations. In this way, the network node 300 will easily receive the current set of network configurations determined by the wireless device 200.

In some embodiments, the determined set of network configurations may enable one or more of: uplink data transmissions; uplink control information transmissions; uplink power control; downlink data transmissions: downlink control information, DCI, transmissions; and sidelink control and/or data transmissions. This means that the set of network configurations may contain network configurations parameters to control uplink power from the wireless device 200. Further, this feature may be combined with pre-determined conditions. This means that network configuration parameters may effect different types of transmissions, and certain sets of network configurations may be adapted to individual scenarios to optimize the power consumption considering all known aspects influencing the intermittent energy source 520 of the wireless device 200.

For example, the wireless device 200 may be configured to use one set of uplink power parameters during night time, and other uplink power parameters during day time. In another example, one set of network configurations may be intended for low-power operation where the energy level at the wireless device 200 may fall below a certain threshold, while another set of network configurations is for normal operation, i.e. when the energy level at the wireless device 200 is above a certain threshold. The wireless device 200 may switch autonomously between the two sets of network configurations based on the energy level of the wireless device 200. When the wireless device 200 switches from normal mode to low-power mode, the wireless device 200 may not inform the network node 300 as the power is low in the wireless device 200. In this case, the network node 300 may performs the previously described detection of switch between the sets of network configurations based on specific transmission characteristics. In some embodiments, a set of network configurations may be determined for each bandwidth part (BWP) used by the wireless device 200.

This section contains further examples combining the above embodiments to illustrate possible usage of multiple sets of network configurations for the wireless device 200, e.g. a self-powered wireless device. In one example, two separate RRC configurations for UL data transmission and UL power control are provided to the wireless device 200 to be used in different power states or modes. One is intended for low-power operation where the energy level at the wireless device 200 may fall below a certain threshold, while another is for the normal operation or normal mode. The wireless device 200 may switch autonomously between the two sets of network configurations based on the energy level of the wireless device 200. When the wireless device 200 switches from the normal mode to the low-power mode, the wireless device 200 may determine not inform the network node 300 because the power or energy level of the wireless device 200 is considered too low. In this case, the network node 300 may perform detection of the switch of the set of network configurations by the wireless device 200 based on specific PRB and/or received power level which the wireless device 200 uses for the UL transmission. On the other hand, when the wireless device 200 switches from low-power mode to normal mode, the wireless device 200 may provide an explicit indication to the network node 300.

In another example, a single network configuration for UL data transmission comprising two sets of values for UL waveform and UL power control parameters are may be provided to the wireless device 200 to be used in different power states or modes. One set is intended for low-power operation where the energy level at the wireless device 200 may fall below a certain threshold, while the other set is for the all other operations, i.e. normal operation or mode. The wireless device 200 may switch autonomously between the two sets of network configurations based on the energy level of the wireless device 200 and may informs the network node 300 about the switch by e.g. sending an explicit indication.

Examples of embodiments of a method performed by a network node 300 for determining a set of network configuration for a wireless device 200 in a wireless communications network 10, will now be described with reference to the flowchart depicted in FIG. 3. FIG. 3 is an illustrated example of actions or operations, which may be taken by the network node 300 in the wireless communications network. The method may comprise the following actions.

### Action 302

In some embodiments, the network node 300 may transmit at least one set of network configurations that are adapted for wireless devices 200 comprising an intermittent energy source 520 to the wireless device 200. In this way, the network node 300 may provide the wireless device 200 with at least one set of network configurations to be used in different states of the power/energy availability on the wireless device 200.

### Action 304

In some embodiments, the network node 300 may transmit network information to the wireless device 200. In this way, the network node 300 may provide the wireless device 200 with network information to be used by the wireless device 200 in the determining the set of network configurations.

In some embodiments, the set of network configurations may enable one or more of: uplink data transmissions; uplink control information transmissions; uplink power control; downlink data transmissions; downlink control information, DCI, transmissions; and sidelink control and/or data transmissions. This means that the network configuration parameters of the determined set of network configurations may effect different types of transmissions, and certain sets of network configurations may be adapted to individual scenarios to optimize the power consumption considering all known aspects influencing the intermittent energy source 520 of the wireless device 200. In some embodiments, a set of network configurations may be determined for each bandwidth part, BWP, used by the wireless device 200.

In some embodiments, the network node 300 may be a wireless device, such as, e.g. the wireless device 201. In this case, the wireless device 201 may be configured to control a Sidelink, SL, or Device-to-Device, D2D, communication with the wireless device 200, e.g. over the wireless connection 132. This means that the wireless device 200 and the wireless device 201 may perform direct communication over a SL/D2D air interface. In other words, the wireless device 201 may act as a master unit, and the wireless device 200 may act as a slave unit in the SL/D2D communication. Accordingly, during the SL/D2D communication, the wireless device 201 may be transmitting 302 at least one set of network configurations that are adapted for wireless device 200 comprising an intermittent energy source 520 to the wireless device 200.

### Action 306

The network node 300 may receive, from the wireless device 200, signaling indicating a set of network configurations that are adapted for wireless device 200 comprising an intermittent energy source 520. This means that the network node 300 may be informed about the current set of network configurations used by the wireless device 200 and/or if there has been a switch in which set of network configurations that is used by the wireless device 200.

In some embodiments, the signaling may indicate the determined set of network configurations by using predetermined settings, or sets, of at least one of the following transmission characteristics: random access channel resource or occasions; uplink control channel resource; power level of the uplink transmission; Physical Resource Blocks, PRBs; symbols or slots that the wireless device 200 used for transmission; waveform of the uplink transmission; and scrambling sequence of uplink RS. In this way, the wireless device 200 may implicitly signal the determined set of network configurations to the network node 300.

In some embodiments, the signaling may comprise receiving a network configuration identifier indicating the determined set of network configurations by the wireless device 200. In this way, the wireless device 200 may explicitly signal the determined set of network configurations to the network node 300.

### Action 308

After receiving signaling indicating the determined set of network configuration in Action 306, the network node 300 may determine the set of network configurations for the wireless device 200 in the wireless communications network 10 according to the indicated set of network configurations. This means that the network node 300 may determine which set of network configurations that has been determined and is currently being used by the wireless device 200 in the wireless communications network 10.

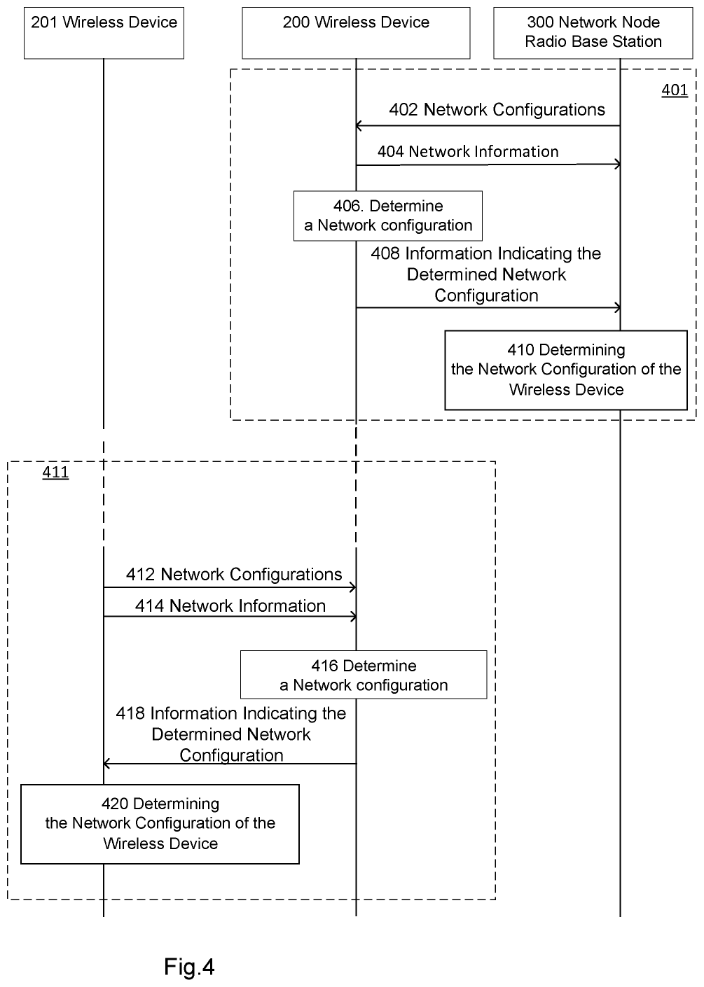

FIG. 4 shows a signalling diagram illustrating two scenario embodiments of a wireless device 200 in a wireless communications network 10 comprising a network node 300 and/or at least one second wireless device 201. The wireless device 200 and the at least one second wireless device 201 may, for example be a self-powered wireless devices.

### Scenario 401

Action 402. The wireless device 200 may obtain at least one set of network configurations that are adapted for wireless devices 200 comprising an intermittent energy source 520 from a network node 300.

Action 404. Optionally, the wireless device 200 may obtain network information.

Action 406. The wireless device 200 may determine a set of network configurations from at least two sets of network configurations comprising the obtained at least one set of network configurations.

Action 408. The wireless device 200 may perform signalling indicating the determined set of network configurations to a network node 300.

Action 410. The network node 300 may determine the set of network configurations for the wireless device 200 according to the indicated set of network configurations.

### Scenario 411

This scenario is similar to Scenario 401 above, except that here it is performed over a sidelink, SL, communication.

Action 412. The wireless device 200 may obtain at least one set of network configurations that are adapted for wireless devices 200 comprising an intermittent energy source 520 from a second wireless device 201.

Action 414. Optionally, the wireless device 200 may obtain network information from a second wireless device 201.

Action 416. The wireless device 200 may determine a set of network configurations from at least two sets of network configurations comprising the obtained at least one set of network configurations.

Action 418. The wireless device 200 may perform signaling indicating the determined set of network configurations to a second wireless device 201.

Action 420. The second wireless device 201 may determine the set of network configurations for the wireless device 200 according to the indicated set of network configurations.

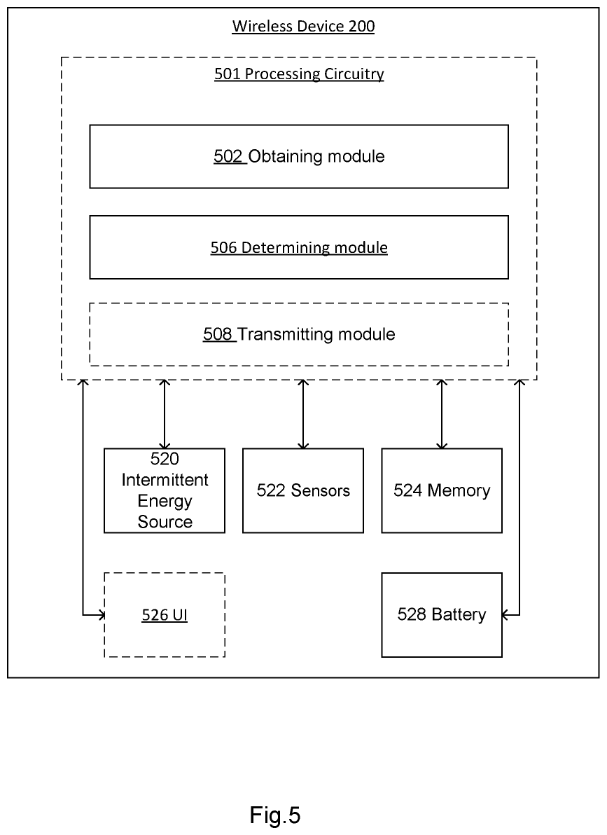

To perform the method actions in a wireless device 200 for determining a set of network configurations for the wireless device 200 in a wireless communications network 10, the wireless device 200 may comprises the following arrangement depicted in FIG. 5. FIG. 5 shows a schematic block diagram of embodiments of a wireless device 200. The embodiments of the wireless device 200 described herein may be considered as independent embodiments or may be considered in any combination with each other to describe non-limiting examples of the example embodiments described herein.

The wireless device 200 may comprise processing circuitry 501, a memory 524 and at least one antenna (not shown). The processing circuitry 501 may also comprise an obtaining module 502, determining module 506 and a transmitting module 508. The obtaining module 502 and the transmitting module 508 may comprise Radio Frequency, RF, circuitry and baseband processing circuitry capable of transmitting a radio signal in the wireless communications network 10. The obtaining module 502 and the transmitting module 508 may also form part of a single transceiver. It should also be noted that some or all of the functionality described in the embodiments above as being performed by the wireless device 200 may be provided by the processing circuitry 501 executing instructions stored on a computer-readable medium, such as, e.g. the memory 524 shown in FIG. 5. Alternative embodiments of the wireless device 200 may comprise additional components, such as, for example, a performing module 510 and sensors 522.

The first wireless device 200 or processing circuitry 501 is configured to, or may comprise the obtaining module 502 configured to, obtain at least one set of network configurations that are adapted for wireless devices 200 comprising an intermittent energy source 520. Also, the wireless device 200 or processing circuitry 501 is configured to, or may comprise the determining module 506 configured to, determine based on information indicating an amount of energy available to the wireless device 200 originating from an intermittent energy source 520 of the wireless device 200, a set of network configurations for the wireless device 200 from at least two sets of network configurations comprising the obtained at least one set of network configurations.

In some embodiments, the wireless device 200 or obtaining module 502 may be configured to, or may comprise the obtaining module 502 configured to, receive at least one set of network configuration from a network node 300 or another wireless device 200 201 in the wireless communications network 10, and/or retrieving at least one set of network configurations predetermined in the wireless device 200.

In some embodiments, the wireless device 200 or performing module 510 may be configured to, or may comprise the performing module 510 configured to, perform signalling indicating the determined set of network configurations to a network node 300 in the wireless communications network 10. In this case, according to some embodiments, the signalling may indicate the determined set of network configurations by using predetermined settings or sets of at least one of the following transmission characteristics, random access channel resource or occasions, uplink control channel resource, power level of the uplink transmission, Physical Resource Blocks (PRBs), symbols or slots that the wireless device 200 used for transmission, waveform of the uplink transmission, and scrambling sequence of uplink RS. Alternatively, in this case, according to some embodiments, the signalling may further comprises transmitting a network configuration identifier indicating the determined set of network configurations.

According to some embodiments the information indicating the amount of energy available to the wireless device 200 may at least partly based on network information received from the network node 300 in the wireless communications network 10, operational information in the wireless device 200, and/or local site information of the wireless device 200. According to some embodiments, the network information may comprise a transmission request from the wireless network node 300 indicating that the wireless network node 300 request transmission from the wireless device 200, information relating to one or more local environmental conditions, and/or an update of one or more of the pre-determined conditions. According to some embodiments, the operational information may comprise at least one of: energy levels of the wireless device 200, profiles of the wireless device 200, duty cycles of the wireless device 200, a charging status of the wireless device 200, and/or traffic profiles of the wireless device 200. According to some embodiments, the local site information may comprises at least one of: a date, a time of day, a period of time, a geographical location of wireless device 200, a local temperature, and/or information indicating one or more local environmental conditions.

In some embodiments, the determined set of network configurations may enable one or more of, uplink data transmissions, uplink control information transmissions uplink power control, downlink data transmissions, downlink control information transmissions; and/or sidelink control and/or data transmissions. In some embodiments, a set of network configurations may be determined for each bandwidth part, BWP, used by the wireless device 200.

Furthermore, the embodiments for determining a set of network configurations for the wireless device 200 in a wireless communications network 10 described above may be implemented through one or more processors, such as the processing circuitry 501 in the wireless device 200 depicted in FIG. 5, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 501 in the wireless device 200. The computer program code may e.g. be provided as pure program code in the wireless device 200 or on a server and downloaded to the wireless device 200. Thus, it should be noted that the modules of the wireless device 200 may in some embodiments be implemented as computer programs stored in memory, e.g. in the memory modules 524 in FIG. 5, for execution by processors or processing modules, e.g. the processing circuitry 501 of FIG. 5. Those skilled in the art will also appreciate that the processing circuitry 501 and the memory 524 described above may refer to a combination of analog and digital circuits, and/or one or more processors configured with software and/or firmware, e.g. stored in a memory, that when executed by the one or more processors such as the processing circuitry 501 perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

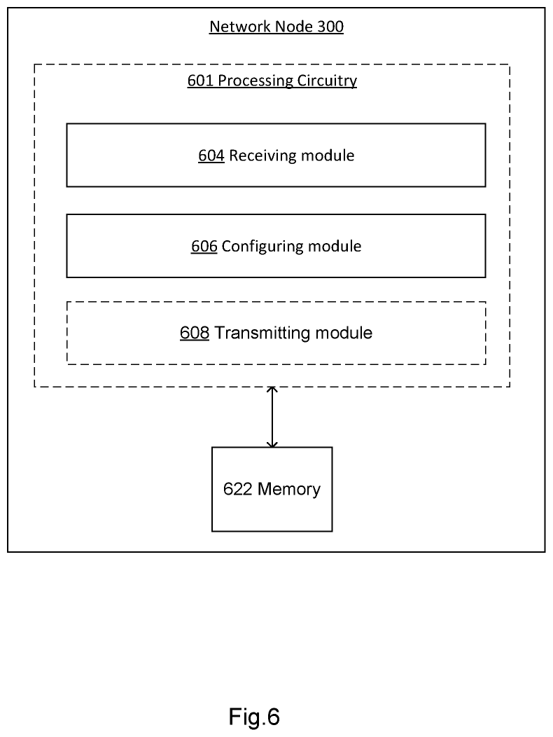

To perform the method actions in network node 300 for determining a set of network configuration for a wireless device 200 in a wireless communications network 10, the network node 300 may comprise the following arrangement depicted in FIG. 6. FIG. 6 shows a schematic block diagram of embodiments of a network node 300. The embodiments of the network node 300 described herein may be considered as independent embodiments or may be considered in any combination with each other to describe non-limiting examples of the example embodiments described herein.

The network node 300 may comprise processing circuitry 601, a memory 622 and at least one antenna (not shown). The processing circuitry 601 may also comprise a receiving module 604, configuring module 606 and a transmitting module 608. The receiving module 604 and the transmitting module 608 may comprise Radio Frequency, RF, circuitry and baseband processing circuitry capable of transmitting a radio signal in the wireless communications network 10. The receiving module 604 and the transmitting module 608 may also form part of a single transceiver. It should also be noted that some or all of the functionality described in the embodiments above as being performed by the network node 300 may be provided by the processing circuitry 601 executing instructions stored on a computer-readable medium, such as, e.g. the memory 622 shown in FIG. 6.

The network node 300 or processing circuitry 601 is configured to, or may comprise the configuring module 606 configured to, receive, from the wireless device 200, signalling indicating a set of network configurations that are adapted for wireless devices comprising an intermittent energy source 520. Also, the network node 300 or processing circuitry 601 is configured to, or may comprise the receiving module 604 configured to, determine the set of network configurations for the wireless device 200 in the wireless communications network 10 according to the indicated set of network configurations.

In some embodiments, the network node 300 or processing circuitry 601 is configured to, or may comprise the transmitting module 608 configured to, transmit at least one set of network configurations that are adapted for wireless devices comprising an intermittent energy source 520 to the wireless device 200. In some embodiments, the network node 300 or processing circuitry 601 is configured to, or may comprise the transmitting module 608 configured to, transmit network information to the wireless device 200.

According to some embodiments, the signalling may indicate the determined set of network configurations by using predetermined settings or sets of at least one of the following transmission characteristics, random access channel resource or occasions, uplink control channel resource, power level of the uplink transmission, Physical Resource Blocks (PRBs), symbols or slots that the wireless device 200 used for transmission, waveform of the uplink transmission, and scrambling sequence of uplink RS. According to some embodiments, the signalling may further comprises receiving a network configuration identifier indicating the determined set of network configurations.

According to some embodiments, the determined set of network configurations may enable one or more of, uplink data transmissions, uplink control information transmissions uplink power control, downlink data transmissions, downlink control information transmissions, and/or sidelink control and/or data transmissions. According to some embodiments, wherein a set of network configurations may be determined for each bandwidth part (BWP) used by the wireless device 200. According to some embodiments, wherein the network node 300 is a wireless device 201 configured to control a Sidelink, SL, or Device-to-Device, D2D, communication with the wireless device 200.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

It should also be noted that the various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The embodiments herein are not limited to the above described preferred embodiments. Various alternatives, modifications and equivalents may be used. Therefore, the above embodiments should not be construed as limiting.

### Abbreviations

ACK Acknowledgement
CE Coverage Enhancement
CSI Channel State Information
DCI Downlink Control Information
D2D Device-to-Device
DL Downlink
eNB evolved Node B
IoT Internet of Things
LTE Long-term Evolution
LPWA Low-power Wide-area
MAC Medium Access Control
MCL Maximum Coupling Loss
MCS Modulation and Coding Scheme
MTC Machine Type Communication
mMTC Massive MTC
NACK Negative Acknowledgement
NB-IoT Narrow-band Internet of Things
NR New Radio
OFDM Orthogonal Frequency-Division Multiplexing
PDCCH Physical Downlink Control Channel
PDSCH Physical Downlink Shared Channel
PRACH Physical Random Access Channel
PRB Physical Resource Block
PUCCH Physical Uplink Control Channel
PUSCH Physical Uplink Shared Channel
Qos Quality of Service
RF Radio frequency
RRC Radio Resource Control
RS Reference Signal
RSRP Reference Signal Receive Power
SINR Signal-to-Interference-plus-Noise Ratio
SPS Semi-persistent scheduling
TBS Transport block size
UE User equipment
UL Uplink
SL Sidelink

1. A method performed by a wireless device for determining a set of network configurations for the wireless device in a wireless communications network, the method comprising:
obtaining at least one set of network configurations that are adapted for wireless devices comprising an intermittent energy source; and
determining, based on information indicating an amount of energy available to the wireless device originating from an intermittent energy source of the wireless device, a set of network configurations for the wireless device from at least two sets of network configurations comprising the obtained at least one set of network configurations.

2.-11. (canceled)

12. A method performed by a network node for determining a set of network configuration for a wireless device in a wireless communications network, the method comprising:
receiving, from the wireless device, signaling indicating a set of network configurations that are adapted for wireless devices comprising an intermittent energy source; and
determining the set of network configurations for the wireless device in the wireless communications network according to the indicated set of network configurations.

13.-19. (canceled)

20. A wireless device for determining a set of network configurations for the wireless device in a wireless communications network being configured to
obtain at least one set of network configurations that are adapted for wireless devices comprising an intermittent energy source, and determine, based on information indicating an amount of energy available to the wireless device originating from an intermittent energy source of the wireless device, a set of network configurations for the wireless device from at least two sets of network configurations comprising the obtained at least one set of network configurations.

21. The wireless device according to claim 20, further configured to receive at least one set of network configuration from a network node or another wireless device in the wireless communications network, and/or retrieve at least one set of network configurations predetermined in the wireless device.

22. The wireless device according to claim 20, further configured to
perform signaling indicating the determined set of network configurations to a network node in the wireless communications network.

23. The wireless device according to claim 20, wherein the signaling indicate the determined set of network configurations by using predetermined settings or sets of at least one of the following transmission characteristics:
random access channel resource or occasions;
uplink control channel resource;
power level of the uplink transmission;
Physical Resource Blocks (PRBs), symbols or slots that the wireless device used for transmission;
waveform of the uplink transmission; and
scrambling sequence of uplink RS.

24. The wireless device according to claim 20, wherein the signaling further comprises transmitting a network configuration identifier indicating the determined set of network configurations.

25. The wireless device according to claim 20, wherein the information indicating the amount of energy available to the wireless device is at least partly based on network information received from the network node in the wireless communications network, operational information in the wireless device, and/or local site information of the wireless device.

26. The wireless device according to claim 20, wherein the network information comprise a transmission request from the wireless network node indicating that the wireless network node request transmission from the wireless device, information relating to one or more local environmental conditions, and/or an update of one or more of the pre-determined conditions.

27. The wireless device according to claim 20, wherein the operational information comprise at least one of:
energy levels of the wireless device;
profiles of the wireless device;
duty cycles of the wireless device;
a charging status of the wireless device; and
traffic profiles of the wireless device.

28. The wireless device according to claim 20, wherein the local site information comprises at least one of:
a date;
a time of day;
a period of time;
a geographical location of wireless device;
a local temperature; and
information indicating one or more local environmental conditions.

29. The wireless device according to claim 20, wherein the determined set of network configurations enable one or more of:
uplink data transmissions;
uplink control information transmissions;
uplink power control;
downlink data transmissions;
downlink control information transmissions; and
sidelink control and/or data transmissions.

30. The wireless device according to claim 20, wherein a set of network configurations is determined for each bandwidth part (BWP) used by the wireless device.

31. The wireless device according to claim 20 comprising a processor and a memory, wherein the memory is containing instructions executable by the processor.

32. A network node for determining a set of network configuration for a wireless device in a wireless communications network being configured to
receive, from the wireless device, signaling indicating a set of network configurations that are adapted for wireless devices comprising an intermittent energy source, and determine the set of network configurations for the wireless device in the wireless communications network according to the indicated set of network configurations.

33. The network node according to claim 32, further configured to transmit at least one set of network configurations that are adapted for wireless devices comprising an intermittent energy source to the wireless device.

34. The network node according to claim 32, further configured to transmit network information to the wireless device.

35. The network node according to claim 32, wherein the signaling indicate the set of network configurations by using predetermined settings or sets of at least one of the following transmission characteristics:
random access channel resource or occasions;
uplink control channel resource;
power level of the uplink transmission;
Physical Resource Blocks (PRBs), symbols or slots that the wireless device use for transmission;
waveform of the uplink transmission; and
scrambling sequence of uplink RS.

36. The network node according to claim 32, wherein the signaling further comprises receiving a network configuration identifier indicating the set of network configurations.

37. The network node according to claim 32, wherein the set of network configurations enable one or more of:
uplink data transmissions;
uplink control information transmissions;
uplink power control;
downlink data transmissions;
downlink control information transmissions; and
sidelink control and/or data transmissions.

38. The network node according to claim 32, wherein a set of network configurations is determined for each bandwidth part (BWP) used by the wireless device.

39. The network node according to claim 32 wherein the network node is a wireless device configured to control a Sidelink, SL, or Device-to-Device, D2D, communication with the wireless device.

40. The network node according to claim 32, comprising a processor and a memory, wherein the memory is containing instructions executable by the processor.

41. A computer program, comprising instructions which, when executed on at least one processor, cause the at least one processor to carry out the method according to claim 1.

42. (canceled)
